(19) United States
(12) Patent Application Publication
(10) Pub. No.: US 2016/0361974 A1
(43) Pub. Date: Dec. 15, 2016

(54) ELECTRIC VEHICLE HEATING DISTRIBUTION SYSTEM AND METHOD

(71) Applicant: FORD GLOBAL TECHNOLOGIES, LLC, Dearborn, MI (US)

(72) Inventors: Angel Fernando Porras, Dearborn, MI (US); Timothy Noah Blatchley, Dearborn (UD)

(21) Appl. No.: 14/735,571

(22) Filed: Jun. 10, 2015

(51) Int. Cl. B60H 1/22; B60H 1/00

(52) U.S. Cl. CPC B60H 1/2218; B60H 1/00899; B60H 2001/224; B60H 2001/2237; B60H 2001/225

(57) ABSTRACT

A heating system for an electric vehicle includes a heat pump subsystem, an electric heater subsystem, and a controller. The heating system further includes one or more sensors for determining an ambient temperature value and a heat pump operational efficiency metric value and for providing those values to the controller. The controller is configured to determine an optimal heating contribution percentage of the heat pump subsystem and the electric heater subsystem from the determined ambient temperature value and the determined heat pump operational efficiency metric value. The heat pump operational efficiency metric may be a compressor discharge pressure value. A related method is described for determining an optimal heating contribution percentage of the heat pump subsystem and the electric heater subsystem.

### TECHNICAL FIELD

This document relates generally to the motor vehicle field and, more particularly, to an electric vehicle heating distribution system and related method.

### BACKGROUND

The broad concept of providing heat for a vehicle such as an electric vehicle by a heat pump is known. However, current heat pump technology, while efficient and economical at higher ambient temperatures, does not admit of efficient or even sufficient heating capabilities at very low ambient temperatures. To address this problem, it is known to supplement heat provided by a heat pump by supplemental heat sources, including heat generated by the vehicle engine (in conventional motor vehicles) or by electric heaters. Problematically, in systems using a heat pump and one or more supplemental heat sources such as an electric heater, for efficient operation of the heating system decisions must be made as to the conditions requiring use of the heat pump, the electric heater, or both depending on ambient conditions. As is known, at higher ambient temperatures it is most efficient to use the heat pump. At low ambient temperatures, it is more efficient to use the electric heater. When both a heat pump and electric heater are in use, decisions must be made as to managing heat capacity distribution to maximize efficiency.

To address these and other issues, the present disclosure describes an electric vehicle heating distribution system including a heat pump and an electric heater, and describes also a related method for managing heat capacity distribution between the heat pump and the electric heater by taking into account factors of ambient temperature and metrics of heat pump efficiency.

### SUMMARY

In accordance with the purposes and benefits described herein, a heating system for an electric vehicle is described, including a heat pump subsystem, an electric heater subsystem, and a controller. One or more sensors provide a determined ambient temperature value and a determined heat pump operational efficiency metric value to the controller. In turn, the controller is configured to determine an optimal heating contribution percentage of the heat pump subsystem and the electric heater subsystem from the determined ambient temperature value and the determined heat pump operational efficiency metric value.

In embodiments, the electric heater subsystem comprises a high voltage electric heater. The heat pump efficiency metric value may comprise a determined heat pump compressor discharge pressure value. At least one of the one or more sensors is an ambient temperature sensor configured to provide the determined ambient temperature value to the controller. At least one of the one or more sensors is a pressure sensor configured to provide the determined heat pump compressor discharge pressure value to the controller.

In other embodiments, the controller may be further configured to compare the determined ambient temperature value to a predetermined ambient temperature threshold value. On determining that the determined ambient temperature value does not exceed the ambient temperature threshold value, the controller may be configured to actuate only the electric heater subsystem.

In another aspect, a method of providing heating to an electric vehicle comprising a heat pump subsystem and an electric heater subsystem as described above is provided. The method includes steps of monitoring an ambient temperature and providing a determined ambient temperature value to a controller, monitoring a heat pump operational efficiency metric and providing a determined heat pump efficiency metric value to the controller, and determining an optimum heating contribution percentage of the heat pump subsystem and the electric heater subsystem from the determined ambient temperature and the determined heat pump efficiency metric. As described above, in embodiments the heat pump operational efficiency metric is a heat pump compressor discharge pressure value and the heat pump sensor is a pressure sensor.

In embodiments, the described method further includes steps of comparing the determined ambient temperature value to a predetermined ambient temperature threshold value, and if the determined ambient temperature value does not exceed the ambient temperature threshold value, actuating only the electric heater subsystem. In turn, the method may include steps of determining an operational status of the heat pump subsystem and the electric heater subsystem and, if the heat pump subsystem is determined to be non-operational, actuating only the electric heater subsystem. On the other hand, if the heat pump subsystem and the electric heater subsystem are determined to be operational, the method includes steps of calculating a heat pump subsystem power multiplier to determine a heating contribution percentage of the heat pump subsystem.

In other embodiments, the heat pump subsystem power multiplier may be a function of the determined ambient temperature value and the heat pump compressor discharge pressure value. The described method includes steps of calculating the heat pump subsystem heating contribution percentage by multiplying the heat pump subsystem power multiplier by the total available energy heating budget, and of calculating the electric heater subsystem heating contribution by subtracting the heat pump subsystem actual power usage from the total available energy heating budget.

In the following description, there are shown and described several preferred embodiments of the battery electric vehicle heating distribution system and method. As it should be realized, the heating distribution system and method are capable of other, different embodiments and their several details are capable of modification in various, obvious aspects all without departing from the system and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the battery electric vehicle heating distribution system and method and together with the description serve to explain certain principles thereof. In the drawing figures:

FIG. 1 is a schematic block diagram of an electric vehicle including a heating system incorporating a high voltage heater and a heat pump; and

FIG. 2 depicts in flow chart format a method for providing heating distribution in an electric vehicle using the climate control system of FIG. 1.

Reference will now be made in detail to the present preferred embodiments of the battery electric vehicle heating distribution system and method, examples of which are illustrated in the accompanying drawing figures.

### DETAILED DESCRIPTION

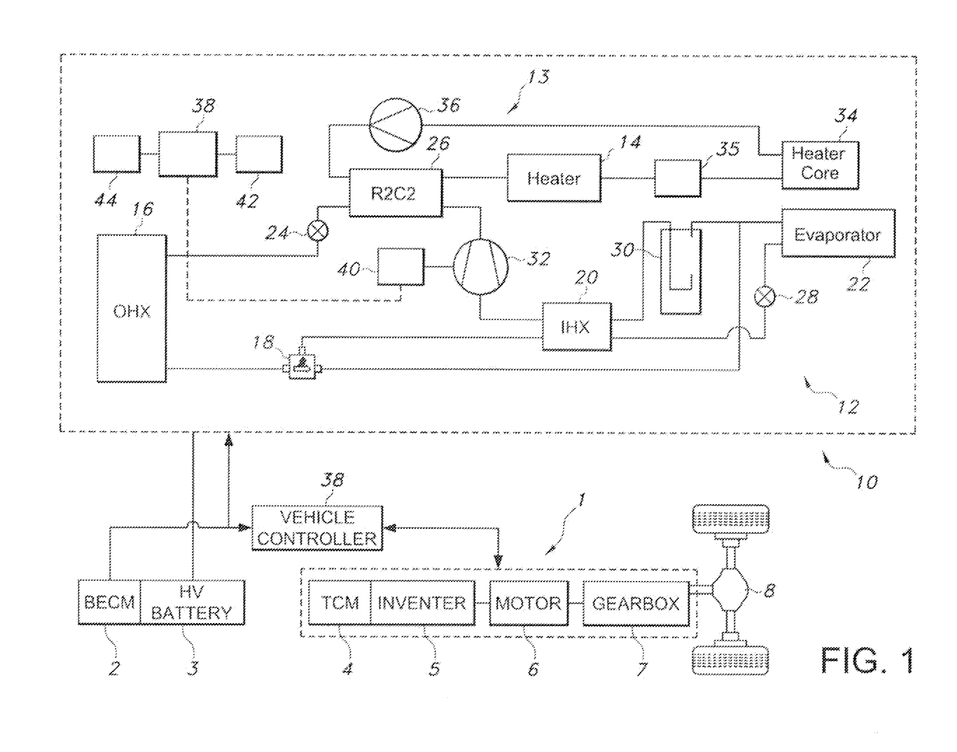

Reference is now made to FIG. 1 which schematically illustrates an electric vehicle 1 of substantially conventional design. Preliminarily, while the present descriptions and drawings primarily describe the disclosed electric vehicle heating distribution system and method in the context of a battery electric vehicle, it will readily be appreciated by the skilled artisan that the disclosed subject matter is readily adaptable to any electric vehicle. At a high level, the term “electric vehicle” as used herein encompasses battery electric vehicles (BEV), hybrid electric vehicles (HEV), plug-in hybrid electric vehicles (PHEV), or indeed any vehicle having an electric vehicle range. Indeed, the claimed subject matter is applicable to any vehicle, electric or otherwise, utilizing in combination a heat pump and electric heater for passenger cabin climate control. Thus, the disclosures should not be taken as limiting.

As background, a BEV includes an electric motor, wherein the energy source for the motor is a traction battery. The BEV traction battery is re-chargeable from an external electric grid. The BEV traction battery is in effect the sole source of on-board energy for vehicle propulsion. A HEV includes an internal combustion engine and an electric motor, wherein the energy source for the engine is fuel and the energy source for the motor is a traction battery. The engine is the main source of energy for vehicle propulsion with the HEV traction battery providing supplemental energy for vehicle propulsion (the HEV traction battery buffers fuel energy and recovers kinematic energy in electric form). A PHEV differs from a HEV in that the PHEV traction battery has a larger capacity than the HEV traction battery and the PHEV traction battery is re-chargeable from the grid. The PHEV traction battery is the main source of energy for vehicle propulsion until the PHEV traction battery depletes to a low energy level at which time the PHEV operates like a HEV for vehicle propulsion.

Returning to FIG. 1, the described battery electric vehicle 1 includes a battery Electric control module 2, an electric battery 3 (in the depicted embodiment a high voltage electric battery), and a transmission control module (TCM) 4 associated with a power inverter 5. The electric vehicle 1 further includes an electric motor 6 which supplies drive power to a gearbox 7, which in turn supplies a drive force to the vehicle axle/ground engaging tires 8.

The described electric vehicle 1 further includes a heating system 10 incorporating a substantially conventional heat pump subsystem 12 and a vehicle passenger cabin electric heater subsystem 13, in the depicted embodiment including a high voltage electric heater 14. The heat pump refrigerant subsystem 12 includes an outside heat exchanger 16, a three-way refrigerant valve 18, an internal heat exchanger 20, and an evaporator 22. A heating electronic expansion valve 24 disperseheated fluids from a refrigerant-to-coolant heat exchanger 26, and a cooling electronic expansion valve 28 supplies cooling fluids to the evaporator 22. The heat pump subsystem 12 further includes an accumulator 30 and a compressor 32. The electric heater subsystem 13 includes a refrigerant to coolant heat exchanger 26, a heater core 34, a heater core temperature (HCT) sensor 35, and a coolant pump 36.

A controller 38 (depicted in association with the vehicle 1 but also the heat pump subsystem 12 and electric heater subsystem 13 for clarity) receives input from sensors associated with the components of the heat pump subsystem 12 and the electric heater subsystem 13, and as will be described infra controls operation of the heat pump subsystem 12 and the electric heater subsystem 13 in order to allocate appropriate portions of the total energy budget for the vehicle between the two components in order to maximize heating efficiency. Such controllers are known in the art, including processors and memory including computer-executable instructions for determining an optimal energy allocation for the heat pump subsystem 12 and the electric heater 14 from stored pre-calibrated data tables. From these data tables, such an optimum energy allocation can be determined as will be described below.

In one embodiment, a sensor 40 is associated with the heat pump compressor 32, for determining a high side pressure discharge value therefrom and communicating that value to the controller 38. Likewise, at least one ambient temperature sensor 42 is provided, for determining an ambient temperature value at an exterior of the vehicle and communicating that value to the controller 38. Still more, a sensor 44 may be associated with the vehicle climate control system, for example with the climate control system control panel (not shown), for communicating to the controller 38 that a request for passenger cabin heating has been manually or automatically generated. Various types and configurations of such sensors are well known in the art, and need not be described fully herein.

As is known, under normal ambient conditions the heat pump subsystem 12 is the most efficient of the two heating subsystems (heat pump and electric heater), and therefore at higher ambient temperatures it is most efficient for the heat pump subsystem 12 to contribute 100% of the heating supplied to the vehicle passenger cabin. However, as is also known, conventional heat pump systems have a minimum operating temperature (for example, this value is currently −4° F. for most conventional motor vehicle heat pump systems). As temperatures approach the heat pump subsystem 12 minimum operating temperature, the energy efficiency of the heat pump system 12 suffers greatly and it is most energy-efficient for the electric heater subsystem 13 to contribute 100% of the heating supplied to the vehicle passenger cabin. As ambient temperatures decrease towards the heat pump subsystem 12 minimum operating temperature, in between those extremes, to maintain maximum energy efficiency during heating the electric heater subsystem 13 contributes increasing percentages of the total heating supplied to the passenger cabin to compensate for decreasing heat pump 12 efficiency at decreasing ambient temperatures.

To address this problem of declining heat pump subsystem 12 energy efficiency as ambient temperatures decrease, the method implemented by the controller 38 and the above-described subsystems includes receiving a heating request, determining whether one or both of the heat pump subsystem 12 and electric heater subsystem 13 are operational, and allocating portions of a total determined energy budget for heating a passenger cabin of a vehicle (not shown) between the heat pump subsystem 12 and the electric heater subsystem 13. At a high level, this is done by distributing power between those two heat sources after receiving a request for heat from a climate system, factoring in a determined ambient temperature and a metric of efficiency of operation of the heat pump subsystem 12. In an embodiment, the metric of efficiency of operation used is a measure of the high side discharge pressure of the heat pump compressor 32.

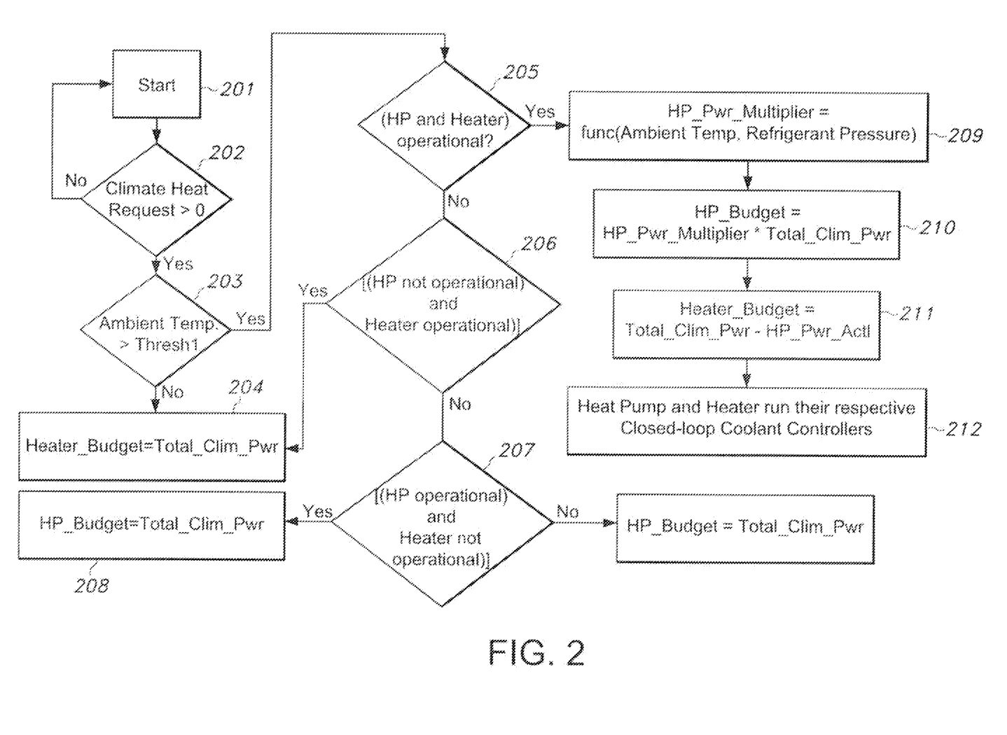

With reference to FIG. 2, the method begins with receiving a heating request (climate heat request>0; step 202). This can be manually, i.e. by a driver or passenger actuating the vehicle climate control system, or automatically, i.e. when a sensor determines that the temperature in the vehicle passenger cabin has decreased below a pre-set value and requires correction.

Next, at step 203 controller 38 determines whether the ambient temperature is above a predetermined threshold, i.e. whether the ambient temperature is above a minimum ambient heat pump operating temperature for the particular heat pump 12 of the vehicle. If not, i.e., if ambient temperature is below that minimum operating temperature for the heat pump, the controller 38 directs 100% of the total energy budget for heating to the electric heater subsystem 13 (step 204).

If the ambient temperature is above a minimum ambient heat pump operating temperature for the particular heat pump subsystem 12 design of the vehicle, at step 205 the controller 38 determines whether both the heat pump subsystem 12 and the electric heater subsystem 13 are operational. If not, the allocation of the total energy budget will depend on which of the two subsystems is operational. If only the electric heater subsystem 13 is operational (step 206), the controller 38 directs 100% of the total energy budget for heating to the electric heater subsystem 13 (step 204). If only the heat pump 12 is operational (step 207), the controller 38 directs 100% of the total energy budget for heating to the heat pump subsystem 12 (step 208).

On the other hand, if both of the heat pump subsystem 12 and the electric heater subsystem 13 are operational, the controller 38 uses input obtained from ambient temperature sensor 42 and heat pump compressor sensor 40 to determine a heat pump power multiplier value (see step 209), and uses that determined power multiplier to calculate, from a maximum energy budget available to the two subsystems, a heat pump energy budget (step 210) and an electric heater energy budget (step 211). Then, each of the heat pump subsystem 12 and electric heater subsystem 13 are caused to operate according to those calculated energy budgets (step 212) by controller 38.

Table 1 below sets forth one possible embodiment of a data table used by controller 38 to determine a heat pump subsystem 12 power multiplier to determine an allocation of energy (power) to the heat pump subsystem 12 from the total energy budget (total power) available. It will be appreciated by the skilled artisan that Table 1 is a calibratable table, that is, that the information therein may be adapted/calibrated to the specifications of different vehicle heat pump subsystems, and so that the specific values depicted therein are not to be taken as limiting.

One axis of the data table shows heat pump compressor 32 high side pressure discharge (kPa) as a measure of heat pump efficiency of operation. The other axis of the data table shows increasing ambient temperature values, beginning at the heat pump subsystem 12 minimum operating temperature (−4° F. for the particular heat pump subsystem 12 used) and showing a high ambient temperature value of 72° F., at which temperature it is unlikely that a vehicle occupant would require significant heating.

TABLE 1
Heat pump power multiplier (heat pump power
distribution from maximum power available).

| High side pressure | Ambient temperature (F.) | | | | | |
|---|---|---|---|---|---|---|
| (kPa) | −4 | 0 | 10 | 20 | 50 | 72 |
| 500 | 0 | 0.15 | 0.25 | 0.5 | 0.75 | 1 |
| 1000 | 0 | 0.15 | 0.15 | 0.4 | 0.75 | 1 |
| 1500 | 0 | 0.1 | 0.15 | 0.3 | 0.5 | 1 |
| 2000 | 0 | 0.1 | 0.2 | 0.2 | 0.5 | 1 |
| 2250 | 0 | 0.05 | 0.05 | 0.15 | 0.35 | 0.75 |
| 2500 | 0 | 0 | 0 | 0.1 | 0.25 | 0.65 |

As can be seen from the foregoing data table, at the lowest selected ambient temperature values (−4° F.), by operation of controller 38 the electric heater subsystem 13 contributes 100% of the passenger cabin heating (heat pump 12 power multiplier=0). As ambient temperatures rise, controller 38 causes the heat pump 12 to contribute an increasing percentage of the passenger cabin heating. For example, on detection of ambient temperatures of 50 and 72° F. (as provided by temperature sensor 42) and on detection of compressor 32 high side pressure values of 500-1000 KPa (by sensor 40), the heat pump power multiplier is respectively calculated to be 0.75 and 1, i.e. a respective contribution of 75 and 100% of the passenger cabin heating from the heat pump subsystem 12. On the other hand, as the heat pump high side compressor 32 pressure values increase, indicative of lesser efficiency of operation of the heat pump 12, the relative contribution of the heat pump 12 to passenger cabin heating decreases, especially at ambient temperatures of 50° F. or less. For temperatures in between the temperatures shown in Table 1, the system provides interpolated respective contributions. For a non-limiting example, for a temperature of 56° F., the system would output an interpolated heat pump contribution of 87.5%. Once these determinations are made, controller 38 causes the heat pump subsystem 12 and the electric heater subsystem 13 to run within their respective closed loops, to in concert heat the passenger cabin in the most energy-efficient manner possible.

Thus, by the foregoing description a simple, efficient, and robust system and method for optimizing heating efficiency in vehicle climate control systems utilizing heat pumps and electric heaters is provided. While the system and method find particular applicability in battery electric vehicles, it will be appreciated by the skilled artisan that the systems and methods are readily adaptable to any vehicle type including a heat pump and an electric heater.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A heating system for an electric vehicle, comprising:
a heat pump subsystem;
an electric heater subsystem;
a controller; and
one or more sensors for providing a determined ambient temperature value and a determined heat pump operational efficiency metric value to the controller.

2. The system of claim 1, wherein the controller is configured to determine an optimal heating contribution percentage of the heat pump subsystem and the electric heater subsystem from the determined ambient temperature value and the determined heat pump operational efficiency metric value.

3. The system of claim 1, wherein the electric heater subsystem comprises a high voltage electric heater.

4. The system of claim 2, wherein the heat pump efficiency metric value comprises a determined heat pump compressor discharge pressure value.

5. The system of claim 1, wherein at least one of the one or more sensors is an ambient temperature sensor configured to provide the determined ambient temperature value to the controller.

6. The system of claim 4, wherein at least another of the one or more sensors is a pressure sensor configured to provide the determined heat pump compressor discharge pressure value to the controller.

7. The system of claim 1, wherein the controller is further configured to compare the determined ambient temperature value to a predetermined ambient temperature threshold value.

8. The system of claim 7, further wherein the controller is configured to, on determining that the determined ambient temperature value does not exceed the ambient temperature threshold value, actuate only the electric heater subsystem.

9. A vehicle including the system of claim 1.

10. A method of providing heating to an electric vehicle comprising a heat pump subsystem and an electric heater subsystem, comprising:
by an ambient temperature sensor, monitoring an ambient temperature and providing a determined ambient temperature value to a controller;
by a heat pump sensor, monitoring a heat pump operational efficiency metric and providing a determined heat pump efficiency metric value to the controller; and
by the controller, determining an optimum heating contribution percentage of the heat pump subsystem and the electric heater subsystem from the determined ambient temperature and the determined heat pump efficiency metric.

11. The method of claim 10, wherein the heat pump operational efficiency metric is a heat pump compressor discharge pressure value.

12. The method of claim 11, wherein the heat pump sensor is a pressure sensor.

13. The method of claim 10, further including, by the controller, comparing the determined ambient temperature value to a predetermined ambient temperature threshold value.

14. The method of claim 13, further including, on determining by the controller that the determined ambient temperature value does not exceed the ambient temperature threshold value, by the controller actuating only the electric heater subsystem.

15. The method of claim 10, further including, by the controller, making a determination of an operational status of the heat pump subsystem and the electric heater subsystem.

16. The method of claim 15, further including, on determining by the controller that the heat pump subsystem is not operational, by the controller actuating only the electric heater subsystem.

17. The method of claim 15, further including, on determining by the controller that the heat pump system and the electric heater subsystem are operational, by the controller calculating a heat pump subsystem power multiplier determining a heating contribution percentage of the heat pump subsystem.

18. The method of claim 17, wherein the heat pump subsystem power multiplier is a function of the determined ambient temperature value and the heat pump compressor discharge pressure value.

19. The method of claim 18, wherein the controller calculates the heat pump subsystem heating contribution percentage by multiplying the heat pump subsystem power multiplier by the total available energy heating budget.

20. The method of claim 12, wherein the controller calculates the electric heater subsystem heating contribution percentage by subtracting the heat pump subsystem actual power usage from the total available energy heating budget.
